(19) United States
(12) Patent Application Publication
(10) Pub. No.: US 2021/0379518 A1
(43) Pub. Date: Dec. 9, 2021

(54) FILTER MEDIA AND METHODS OF MAKING AND USING

(71) Applicant: W. L. Gore & Associates, Inc., Newark, DE (US)

(72) Inventors: Wai Sing Poon, Hockessin, DE (US); Stephen K. Stark, Wilmington, DE (US)

(21) Appl. No.: 17/340,968

(22) Filed: Jun. 7, 2021

Related U.S. Application Data
(60) Provisional application No. 63/036,262, filed on Jun. 8, 2020.

(51) Int. Cl. B01D 39/16; B01D 46/00

(52) U.S. Cl. CPC B01D 39/16; B01D 46/0032; A62B 23/025; B01D 2239/0654; B01D 2239/0435

(57) ABSTRACT

Exemplary embodiments of filter media and methods of making and using them are disclosed.

### BACKGROUND OF THE INVENTION

### Field of the Invention

The present invention relates to high-efficiency filter media that can be used in a wide variety of applications, including without limitation filtration masks, respirators, powered air purification devices (PAPD), ventilators, and in other filter applications, and methods for manufacturing and using the same.

### Discussion of the Related Art

Respirators are commonly made with electrostatically charged melt-blown non-woven material due to its high efficiency and low pressure drop. Due to recent shortages of melt-blown media, there is a need to use alternative materials. Microporous membranes capture particles efficiently, but if they rely only upon mechanical filtration, the pressure drop through such media can be relatively high compare to electrostatically charged melt-blown media. U.S. Pat. No. 7,501,003 describes a successful composite filter media that combines electrostatically charged melt-blown media with ePTFE membrane. It is believed to be beneficial to enhance the filtration efficiency of membrane filters without using electrostatically charged melt-blown materials.

The present invention rectifies deficiencies presently not addressed in the art.

### SUMMARY OF THE INVENTION

Improved filter media are disclosed that comprise at least one fibrous layer that has a first triboelectric charge and at least one membrane layer that has a second, substantially different triboelectric charge. By intentionally allowing an electrical charge to form within the filter media, such as by allowing the differently charged materials to move relative to each other or by otherwise creating a charge within the filter media, the filter media will exhibit both mechanical filtration and electrostatic filtration. A more efficient filter, such as one that provides both effective filtration efficiency while also allowing good airflow, may thereby be created.

### BRIEF DESCRIPTION OF THE DRAWINGS

The accompanying drawings are included to provide a further understanding of the invention and are incorporated in and constitute a part of this specification, illustrate embodiments of the invention, and together with the description serve to explain the principles of the invention.

FIG. 1 is a schematic cross section view of a two-layer embodiment of filter media as described herein.

FIG. 2 is a schematic cross section of three-layer embodiment of filter media as described herein.

FIG. 3 is a schematic cross section of four-layer embodiment of filter media as described herein.

FIG. 4 is a schematic cross section of five-layer embodiment of filter media as described herein.

FIG. 5 is a photograph of a surface of an embodiment of a filter media as described herein.

FIG. 6 is a photograph of a surface of further embodiment of a filter media as described herein.

FIG. 7 is a photograph of a surface of another embodiment of a filter media as described herein.

FIG. 8 is a photograph of a surface of still another second embodiment of a filter media as described herein.

FIG. 9 is a schematic representation of one method of forming a triboelectric charge within the filter media described here.

FIG. 10A is a schematic representation of another method of forming a charge within the filter media described herein.

FIG. 10B is a schematic representation of still another method of forming a charge within the filter media described herein.

FIG. 11 is an exploded view of the filter media shown incorporated into an illustrative filter cartridge and facemask.

FIG. 12 an opposite exploded view of the filter media, filter cartridge, and facemask shown in FIG. 11.

FIG. 13 is a front view of a person wearing a powered air purification device incorporating an embodiment of a filter cartridge incorporating the filter media as disclosed herein.

FIG. 14 is a front view of a person wearing a facemask incorporating an embodiment of a filter cartridge employing one embodiment of a filter media disclosed herein.

FIG. 15 is a side view of a person wearing a facemask incorporating one embodiment of a filter media disclosed herein.

### DETAILED DESCRIPTION OF THE ILLUSTRATED EMBODIMENTS

Persons skilled in the art will readily appreciate that various aspects of the present invention may be realized by any number of methods and apparatuses configured to perform the intended functions. Stated differently, other methods and apparatuses may be incorporated herein to perform the intended functions. It should also be noted that the accompanying drawing figures referred to herein are not all drawn to scale, but may be exaggerated to illustrate various aspects of the present invention, and in that regard, the drawing figures should not be construed as limiting.

Although the present invention may be described in connection with various principles and beliefs, the present invention should not be bound by theory.

Improved filter media described herein comprise at least one first layer that has a first triboelectric charge and at least one second layer that has a second, substantially different triboelectric charge. By intentionally allowing an electrical charge to form within the filter media, such as by allowing the differently charged materials to move relative to each other or by otherwise creating a charge within the filter media, the filter media will exhibit both mechanical filtration and electrostatic filtration.

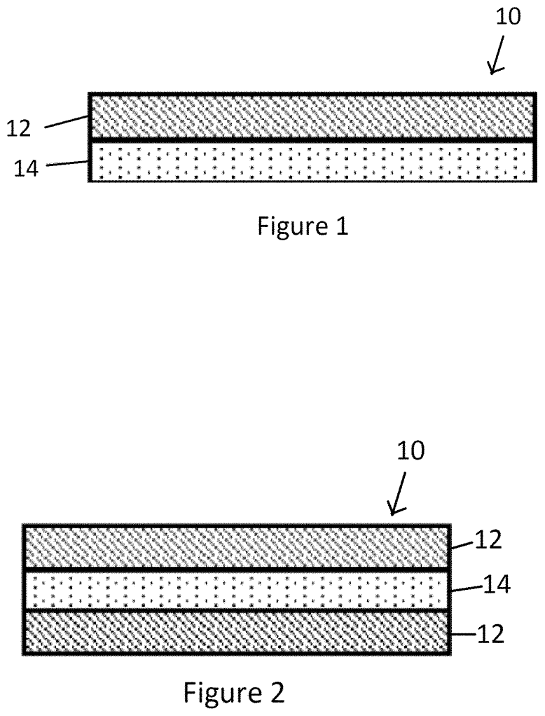

Shown in the drawings are various embodiments of filter media described herein. FIG. 1 illustrates a filter media 10 having a first layer 12 and a second layer 14. In this instance the first layer 12 comprises a support layer that provides support for the filter media. Material for the first layer 12 is selected to present a first triboelectric charge. The second layer 14 illustrated comprises a mechanical filtration layer, such as a membrane or nanofiber material (referred to generally as a “microporous material” herein). Material for the second layer 14 is selected to present a second triboelectric charge that is distinct from the triboelectric charge of the first layer 12 so as to promote generation and/or maintenance of electrostatic charge within the filter media 10 during use.

The support layer 12 may comprise any material having an open support structure, such as a fibrous material. Suitable materials may include, without limitation, a spunbond non-woven, polypropylene (PP), polyamide (PA), polyethylene terephthalate (PET), polyimide (PI), etc.

The microporous layer 14 may comprise any material that provides a sufficiently dense structure to promote mechanical filtration at a desired filtration level while still allowing for sufficient air permeability. Suitable materials may include, without limitation, a membrane material such as expanded polytetrafluoroethylene (ePTFE) (e.g., having a Frazier air permeability of about 1 to 200, or more specifically about 20 to 150, or more specifically about 30 to 120, or more specifically about 40 to 100) or ultra-high molecular weight polyethylene (UPE), or a nanofiber layer such as polyvinylidene fluoride or polyvinylidene difluoride (PVDF), polytetrafluoroethylene (PTFE), or polyacrylonitrile (PAN), polyamide (PA).

As has been noted, the two layers 12, 14 should have distinct triboelectric charges so as to promote and maintain electrostatic charge within the material. By providing such a charge, the material will attract and retain particles so as to increase filtration efficiency of the filter media, without unduly limiting air flow through the filter media. The two materials can be selected along the triboelectric series as follows:

The greater the differences of the two materials along this spectrum, the greater the tendency to increase the build-up and maintenance of static electric charge within the filter media. Thus combining, for instance, a layer of PTFE (highly negatively charged) with a layer of PA (nylon 6,6) (highly positively charged) will promote a greater static electric charge in the filter media. It should be appreciated that the selection of material for the support layer 12 and the microporous layer 14 may be reversed while still achieving the benefits of the present concepts, for example employing a PTFE support layer and a PA microporous layer.

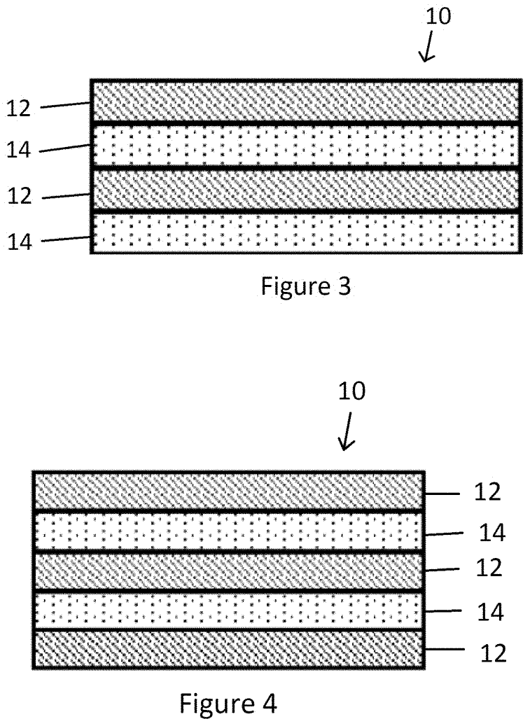

As is illustrated in FIGS. 2 through 4, support layer 12 and microporous layer 14 may be alternately stacked in a variety of ways to achieve the right balance of mechanical filtration, support of the microporous layer(s), generation and/or maintenance of electrical charge, and airflow.

It should be appreciated that different support materials and microporous materials may be combined in a variety of ways while still achieving the results described herein, including providing six or more layers or layers of mixed materials. Additionally, other materials may be combined with the filter media described herein to provide additional protection to the materials or provide additional filtration, support, or other properties.

Without intending to limit the scope of the present invention, the following examples illustrate various constructions of filter media that may be created in accordance with the present disclosure:

Example 1:

| | |
|---|---|
| Layer 1: | nylon spunbond, 84 g/m2 (Cerex 23200, available from |
| | Cerex, Cantoment, FL) |
| Layer 2: | 100 Frazier (F) ePTFE Membrane (available from |
| | W.L. Gore & Associates, Inc., Elkton, MD (Gore)) |
| Layer 3: | nylon spunbond, 84 g/m2 (Cerex 23200, Cerex) |
| Bonding: | None, layers are stacked together |

Example 2:

| | |
|---|---|
| Layer 1: | polyester spunbond, 70 g/m2 (Reemay 2024, available from |
| | Berry, Old Hickory, TN) |
| Layer 2: | 100F ePTFE Membrane (Gore) |
| Layer 3: | polyester spunbond, 70 g/m2 (Reemay 2024, Berry) |
| Bonding: | None, layers are stacked together |

Example 3:

| | |
|---|---|
| Layer 1: | nylon spunbond, 84 g/m2 (Cerex 23200, Cerex) |
| Layer 2: | 40F ePTFE Membrane (Gore) |
| Layer 3: | nylon spunbond, 84 g/m2 (Cerex 23200, Cerex) |
| Bonding: | None, layers are stacked together |

Example 4:

| | |
|---|---|
| Layer 1: | polypropylene spunbond, 60 g/m2 (Part No. |
| | PPSBWL60W1245P1000, available from Avanti, |
| | Clarksville, TN) |
| Layer 2: | 40F ePTFE Membrane (Gore, Part No. 10346NA) |
| Layer 3: | polypropylene spunbond, 60 g/m2 (Part No. |
| | PPSBWL60W1245P1000, Avanti) |
| Bonding: | The layers are point bonded by ultrasonic welding per |
| | U.S. Pat. No. 8,147,583, incorporated in its entirety by |
| | reference herein. |

Example 5: (to be sampled)

| | |
|---|---|
| Layer 1: | nylon spunbond, 84 g/m2 (PBN II 30200, Cerex) |
| Layer 2: | 40F ePTFE Membrane (Gore) |
| Layer 3: | nylon spunbond, 84 g/m2 (PBN II 30200, Cerex) |
| Bonding: | The layers are point bonded by ultrasonic welding per |
| | U.S. Pat. No. 8,147,583. |

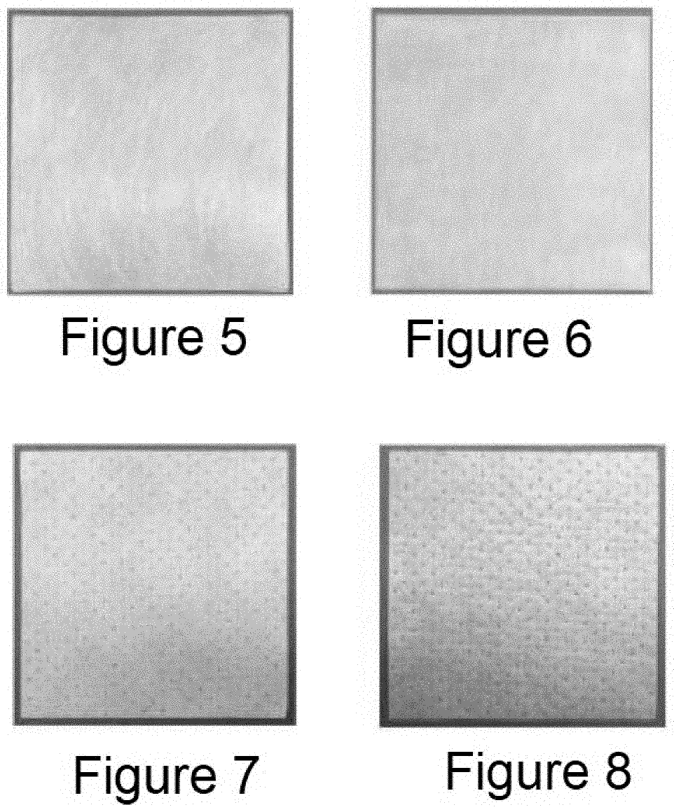

These various examples are illustrated in the photographs of FIGS. 5 through 8. FIG. 5 shows the surface of filter media made in accordance with Example 2. FIG. 6 shows the surface of filter media made in accordance with Examples 1 and 3. FIG. 7 shows the surface of filter media made in accordance with Example 4. FIG. 8 shows the surface of filter media made in accordance with Example 5.

These various filter media are tested and perform as follows:

Test Method:

Particle collection efficiency and airflow resistance are measured by an automated tester, Model 3160 from TSI, Inc. (from Shoreview, Minn., USA). The tester generates monodisperse particles of a known size and uses them to challenge the filter. The particle concentrations upstream and downstream of the filter are measured to determine the fraction of particles that penetrated the filter.

A dioctyl-pthalate (DOP) solution in isopropyl alcohol is atomized to generate a polydisperse aerosol. The aerosol particles are then classified with an electrical mobility analyzer to generate monodisperse particles in the size range from 0.03 to 0.4 μm in diameter. The particles are then used to challenge the test filter mounted horizontally inside a sealed filter holder. The test filter is a flat sheet sample, 152.4 mm in diameter. The center test zone area is 100 cm². Two condensation nucleus particle counters are simultaneously used to measure the particle concentrations upstream and downstream of the test filter. The efficiency of the filter is reported as the percentage of particles collected by the filter relative to the upstream challenge particles. The pressure drop is recorded in mm of water. The test is performed at ambient room temperature (70° F.) and relative humidity (40%) conditions.

Penetration:

Ratio of particles concentration downstream of the filter to upstream of the filter. Measurement was made for 0.1 micron particle size at 5.3 cm/s.

Specific Quality:

Ratio of loci of particles penetration to differential pressure drop, 1/rayl

$$SQ = \frac{- log ( Pen )}{( \frac{Δ P}{U} )}$$

SQ—specific quality, 1/rayls

Pen—fractional particle penetration

ΔP—differential pressure drop, Pascal

U—media face velocity, m/s

Summary of Filtration Media Examples:

| | Gore Membrane | Fibrous Layer |
|---|---|---|
| Example 1 | 100F | Cerex 23200, PA |
| Example 2 | 100F | Reeman 2024, PET |
| Example 3 | 40F | Cerex 23200, PA |
| Example 4 | 40F | Avanti 60, PP |
| Example 5 | 40F | PBN II 30200, PA |

Filtration performance of 0.1 um DOP particles at 5.3 cm/s:

| | Penetra- | Penetra- | | Specific | Specific | |
|---|---|---|---|---|---|---|
| | tion | tion | | Quality, | Quality | |
| | Control, | Charged, | % | Control | Charged, | % |
| | % | % | Change | 1/rayls | 1/rayls | Change |
| Example 1 | 48.1 | 32.3 | −33% | 0.589 | 0.867 | +47% |
| Example 2 | 39.4 | 27.4 | −30% | 1.398 | 1.996 | +43% |
| Example 3 | 7.7 | 4.2 | −45% | 0.983 | 1.197 | +22% |
| Example 4 | 5.0 | 3.5 | −30% | 1.186 | 1.343 | +13% |
| Example 5 | 7.1 | 4.0 | −44% | 1.16 | 1.33 | +15% |

Properties and filtration performance of 0.1 um DOP particles at 5.3 cm/s:

| | Membrane 40F | Membrane 100F |
|---|---|---|
| Thickness, μm | 53 | 43 |
| Basis weight, g/m² | 2.02 | 0.92 |
| Bubble Point, psi | 1.69 | 1.4 |
| MD-Peak Tensile Load, | 0.6 | 0.38 |
| lbf/in | | |
| TD-Peak Tensile Load, | 0.17 | 0.11 |
| lbf/in | | |
| Air Permeability, | 38 | 104 |
| CFM/ft²@0.5″H₂O | | |
| Pressure drop, mmwg | 4.8 | 0.9 |
| Particles Penetration | 7.5 | 55.0 |

Support layer properties:

| | | Cerex | PBN II | Reemay | Avanti |
|---|---|---|---|---|---|
| | Unit | 23200 | 30200 | 2024 | 60 |
| Material | | PA | PA | PET | PP |
| Bonding | | Flat Bond | Point Bond | Flat Bond | Point Bond |
| Basis | g/m² | 68 | 2 | 2.1 | 60 |
| Weight | | | | | |
| ASTM | | | | | |
| D3776 | | | | | |
| Thickness | Mils | 8.4 | 15.2 | 12 | 15 |
| ASTM | | | | | |
| D1777 | | | | | |
| Mullen | PSI | 62 | 54 | 52 | 50 |
| Burst | | | | | |
| ASTM | | | | | |
| D3786 | | | | | |
| Grab | Lbs | 69.7 × 48.0 | 65.9 × 50.5 | 62 × 47 | 32.5 × 31.0 |
| Tensile, | | | | | |
| MD × CD | | | | | |
| ASTM | | | | | |
| D5034 | | | | | |
| Air Perm | CFM/ft² | 170 | 304 | 310 | 210 |
| ASTM | | | | | |
| D737 | | | | | |

Filter media constructed as disclosed herein may be electrically charge by either the creation of static electric charge through triboelectric interaction by movement of the support layer(s) and the microporous layer(s) against each other, or by imparting electric charge through treatment of the filter media, or by a combination of both of these methods.

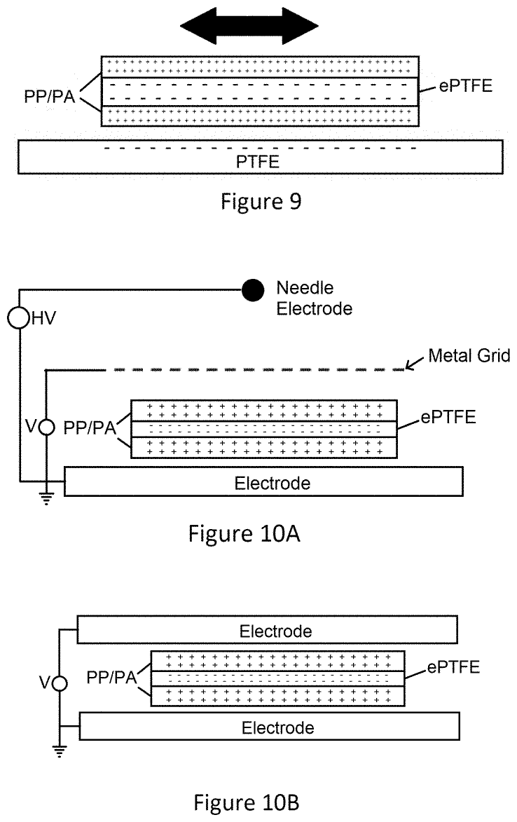

FIG. 9 schematically illustrates a triboelectric charging of a three-layer filter media described herein whereby movement between the layers is generated by a method such as contact electrification (e.g., by relative movement of the layers through mechanical actuation of the filter media, including through normal use of the filter media) and/or by other movement imparted to the filter media, such as through sonic or ultrasonic vibration.

By mounting the support layer(s) and the microporous layer(s) together as described in the above examples with no intermediate bonding between the layers or with discontinuous bonding between the layers (such as through the methods described in U.S. Pat. No. 8,147,583) (collectively referred to herein as “non-continuous bonding), it allows for relative movements between the layers so as to assist in generating static electric charges in this manner.

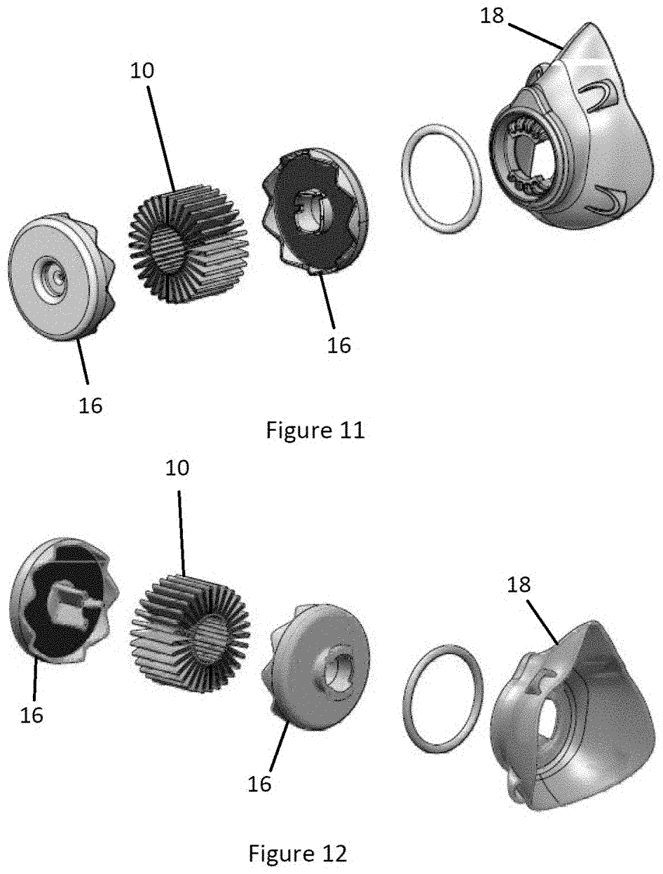

Alternatively or additionally, as is shown in FIGS. 10A and 10B electrical charge can be imparted by externally applying electric charge to the filter media. FIG. 10A illustrates apparatus for applying an electrical charge to the filter media via corona charging using high voltage. FIG. 10B illustrates apparatus for applying an electrical charge to the filter media via thermal poling charging. By charging with an external charging source, such as with one of these methods, the filter media can employ non-continuous bonding, as described above, or continuous bonding between the layers.

The filter media described herein may be arranged in any desired configuration, for example as a flat sheet, in a cylinder, in pleats, or in various convoluted shapes. By forming the filter media with multiple pleats or other convoluted configuration, the surface area may be increased to allow for greater filter efficiency and greater airflow.

It should be appreciated that by providing increased electrostatic filtration within the filter media, it allows a filter designer to reduce the pressure drop required from use of a mechanical filter alone. As such, a less robust mechanical filter may be utilized, thus potentially increasing airflow through the filter media without reducing filter effectiveness.

One desirable application for the filter media described herein is use in various facemasks, filtration masks, respirators, air purification systems, powered air purification devices (PAPD), ventilators, and other personal protective equipment (PPE). The filter media described herein is particularly useful for these kinds of applications because of its high filtration efficiency while being able to accommodate excellent airflow needed for respiration. The filter media described herein is believed to be suitable for use in N95 (NIOSH) facemasks and similar protection and filtration devices

For example, FIGS. 11 and 12 illustrate the filter media 10 arranged in a pleated configuration, mounted into a filtration cartridge 16 adapted for attachment to a face mask 18.

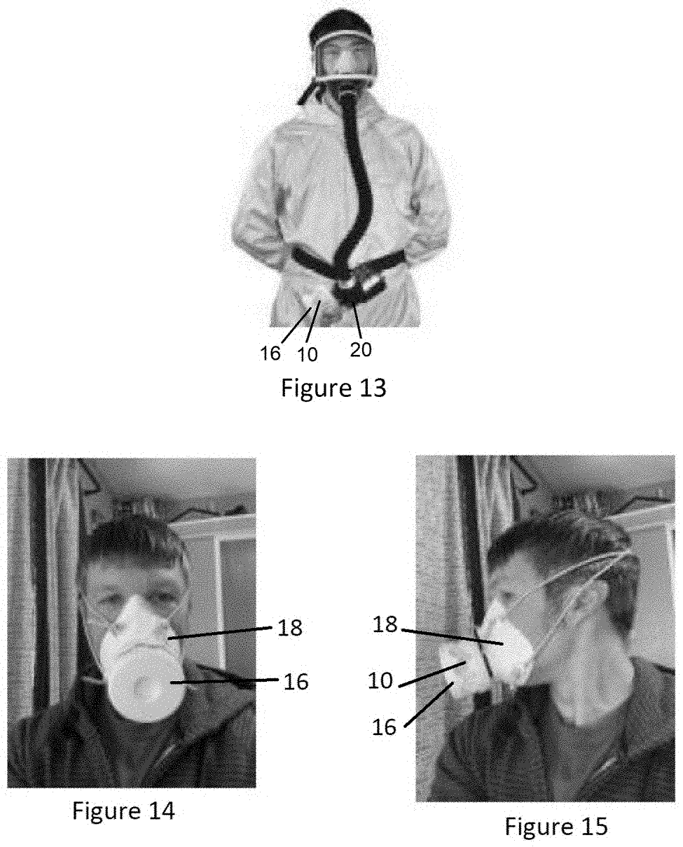

FIG. 13 shows a filter cartridge 16 containing the filter media 10 described herein mounted on a powered air purification device 20.

FIGS. 14 and 15 illustrate a filter cartridge 16 incorporating the filter media 10 described herein mounted on a facemask 18.

It is beneficial to be able to clean, replenish or otherwise restore filter media to extend the life of the filter cartridge describe herein. Options include without limitation washing with water and soap, sterilizing (such as in autoclave or with EtO or other suitable substance or process), or disinfecting. Many of the materials described herein are particularly resistant to common disinfecting and sterilization methods commonly found in healthcare facilities, such as with use of isopropynol alcohol (IPA) and/or steam sterilization. As such, incorporation of the filter media described herein into facemasks, respirators, ventilators, and similar personal protective equipment (PPE) designed to protect first responders, healthcare provides, patients, and the like may allow for effective prolonged use of such devices after then are repeatedly replenished.

Benefits of the described filter media include, without limitation:
prolonged retention of electrostatic charge maintains filter efficiency while allowing for more airflow through the filter media. This makes the filter media particularly beneficial for use with filter masks, respirators, ventilators and similar devices that require good airflow to support respiration;
filter media can be cleaned, sterilized, disinfected, or other action to replenish the filter media. This can greatly extend the effective life of the filter media and any devices employing it;
ease in creating and maintaining electric charge in the media, allowing for user reactivation of the filter media, such as after cleaning or sterilization.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A composite filter media that comprises:
at least one support layer that has a more positive triboelectric charge;
at least one microporous layer that has a more negative triboelectric charge; and
wherein the support layer and the microporous layer are non-continuously bonded to each, allowing the two layers to move relative to each other sufficiently to cause a static electrical charge to be generated within the filter media.

2. The composite filter media of claim 1, wherein the support layer comprises a polyimide.

3. The composite filter media of claim 1, wherein the support layer comprises a polyimide.

4. The composite filter media of claim 1, wherein the support layer comprises a polypropylene.

5. The composite filter media of claim 1, wherein the support layer comprises a PET.

6. The composite filter media of claim 1, wherein the microporous layer comprises a polytetrafluoroethylene.

7. The composite filter media of claim 6, wherein the microporous layer comprises an expanded polytetrafluoroethylene.

8. The composite filter media of claim 1, wherein the microporous layer comprises a polyethylene.

9. The composite filter media of claim 1 that comprises at least two support layers sandwiching at least one microporous layer.

10. A composite filter media that comprises:
at least one support layer that has a more positive triboelectric charge;
at least one microporous layer that has a more negative triboelectric charge; and
wherein the filter media is configured to accept an electrical charge imparted to filter media prior to use.

11. The composite filter media of claim 10, wherein the support layer and the microporous layer are non-continuously bonded to each.

12. The composite filter media of claim 11, wherein the support layer and the microporous layer are configured to allow the two layers to move relative to each other sufficiently to cause a static electrical charge to be generated within the filter media.

13. The composite filter media of claim 10, wherein the support layer and the microporous layer are continuously bonded to each.

14. The composite filter media of claim 10, wherein electrical charge is imparted through corona treatment.

15. The composite filter media of claim 10, wherein electrical change is imparted through ultrasonic treatment.

16. A composite filter media that comprises:
at least one support layer that has a more negative triboelectric charge;
at least one microporous layer that has a more positive triboelectric charge; and
wherein the support layer and the microporous layer are non-continuously bonded to each, allowing the two layers to move relative to each other sufficiently to cause a static electrical charge to be generated within the filter media.

17. A composite filter media that comprises:
at least one support layer that has a more negative triboelectric charge;
at least one microporous layer that has a more positive triboelectric charge; and
wherein the filter media is configured to accept an electrical charge imparted to filter media prior to use.
